(19) United States
(12) Patent Application Publication
(10) Pub. No.: US 2013/0068982 A1
(43) Pub. Date: Mar. 21, 2013

(54) BALL VALVE

(71) Applicants: Fabian Wijnand Alink, Duiven (NL); Patrick Anthonius Hendrikus Maria Nootebos, Duiven (NL)

(72) Inventors: Fabian Wijnand Alink, Duiven (NL); Patrick Anthonius Hendrikus Maria Nootebos, Duiven (NL)

(73) Assignee: INDUFIL B.V., RS Duiven (NL)

(21) Appl. No.: 13/583,333

(22) PCT Filed: Mar. 8, 2010
(86) PCT No.: PCT/NL2010/050112

§ 371 Date: Oct. 2, 2012

(51) Int. Cl. F16K 5/06

(52) U.S. Cl. 251/315.1; 137/315.2

(57) ABSTRACT

A ball valve operative in a cryogenic temperature range, includes a housing having a fluid passage therethrough, a ball rotatably positioned in the fluid passage and including a fluid passage therethough, the fluid passages of the housing and the ball allowing fluid through the ball valve when the ball is in an open position and block the fluid when the ball is rotated into a closed position. The housing includes at least two sealing rings disposed therein, sealingly contacting the ball and positioned for rotatably holding the ball between the two sealing rings which include at least a surface layer of thermoplastic material contacting the ball surface and having an annular, circumferential groove in a contacting surface where the rings sealingly engage the ball and an annular recess in the sealing ring opposite to the circumferential groove for providing a spring lip for biasing the sealing ring against the ball.

### BACKGROUND

The present invention relates to a ball valve operative in a cryogenic temperature range, said ball valve comprising a housing comprising a fluid passage therethrough, a ball rotatably positioned in said housing in said fluid passage and comprising a fluid passage therethough, said fluid passage of said housing and said fluid passage of said ball provided to allow fluid through said ball valve when said ball is in an open position and to block said fluid when said ball is rotated from said open position into a closed position, wherein said housing comprising at least two sealing rings disposed in said housing, and sealingly contacting said ball and positioned for rotatably holding said ball between said at least two sealing rings

A ball valve in general is disclosed in U.S. Pat. No. 6,969,047, for instance. The two way ball valve disclosed in this publication has a specially designed sealing ring made from thermoplastic material. In these ball valves the ball is said to float against the sealing surface of two opposite sealing rings. The sealing rings in this ball valve are part of sealing assemblies comprising several separate parts. The ball valve is said to have an improved pressure and temperature performance, although no specific operating ranges are disclosed. According to this document, the sealing ring can been made from PEEK in order to improve high temperature performance. The publication refers to cryogenic temperatures, but does not couple this to the specific use of PEEK. It was found that operating performance at lower temperatures leave room for improvement.

### SUMMARY OF THE INVENTION

The invention aims to improve ball valves, in particular in floating ball valves.

Another object of the invention is to improve ball valves when used at lower temperatures. A particular object of the invention is to improve ball valves for use at cryogenic temperatures.

According to a first aspect of the invention this is realized with a ball valve operative in a cryogenic temperature range, said ball valve comprising a housing comprising a fluid passage therethrough, a ball rotatably positioned in said housing in said fluid passage and comprising a fluid passage therethough, said fluid passage of said housing and said fluid passage of said ball provided to allow fluid through said ball valve when said ball is in an open position and to block said fluid when said ball is rotated from said open position into a closed position, wherein said housing comprising at least two sealing rings disposed in annular recesses in said housing for sealingly contacting said ball and positioned for rotatably holding said ball between said at least two sealing rings, said sealing rings comprising at least a surface layer of thermoplastic material contacting said ball surface and comprising an annular, circumferential groove in a contacting surface where said sealing rings sealingly engage said ball, and an annular recess in said sealing ring opposite to said circumferential groove for providing a spring lip for biasing said sealing ring against said ball.

The lip provides an integrated cup spring or Belleville spring washer. When said sealing ring is mounted in said annular recess in the housing, the lip forces said sealing ring in the direction out of its annular recess in the housing and against the ball. Furthermore, when there is fluid overpressure on one of the fluid passages, the pressure in the annular recess of the sealing ring in that fluid passage presses the lip against the housing and thus the sealing lip against the ball, providing better sealing properties.

The circumferential groove provides two distinct sealing surfaces, also at low pressure. Furthermore, contamination will be scraped off of the ball.

In an embodiment, said thermoplastic material has a Young's modulus between 2500 and 10000 MPa at room temperature and an elongation at break of at least 2% at a temperature below 80 K.

The combination of compression modulus and annular groove provides a ball valve which can operate at cryogenic temperatures and at high pressures of up to 100 bar and more, even up to 225 bar and more. In this respect, cryogenic temperatures refer to a temperature below 100 K, in particular below 80K. Furthermore, it will remain leak tight also at low pressure.

In an embodiment of the invention, the housing comprises at least two annular recesses adjacent to said ball and each holding a sealing ring disposed in said annular recess to sealingly contact said ball. These annular recesses in the housing are in an embodiment opposite one another.

In an embodiment, the ball valve has an asymmetric mass distribution due to its fluid passage. In an embodiment, the passage through said ball is not a straight channel through said ball. In an embodiment, the passage through said ball comprises at least one bend. In these asymmetric embodiments, change of temperature will severely challenge the sealing properties. An example of a valve with an “asymmetric ball” is a three-way ball valve.

In an embodiment, the housing comprises at least two modular housing parts. In an embodiment, a first modular housing part comprises at least one fluid passage end dimensioned for housing the ball and having two opposite coupling ends, and a second modular housing part comprising a fluid passage, an annular recess for holding one sealing ring at one end of the fluid passage, and a coupling end for coupling to one coupling end of said first modular housing part such that in a coupled position said sealing ring presses its contacting surface against the ball. In an embodiment, a further, similar second modular housing part is connected to the other, opposite coupling end of the first modular housing part, thus floatingly clamping the ball between two sealing rings.

In an embodiment, the fluid passage of said ball comprises a bend and said housing comprises at least three fluid passage ends connecting to said ball and wherein said fluid passage of said ball and said fluid passage ends of said housing arranged with respect to said ball and said fluid passage of said ball to allow interconnection of sets of two fluid passage ends.

In an embodiment, the sealing ring is substantially made from said polymer material.

In an embodiment, the sealing ring comprises at least a core of said polymer material.

In an embodiment, the sealing ring is substantially from said polymer material and said annular recess of said sealing ring comprises circumferential indentations in both opposite sidewalls, in an embodiment said sealing ring comprises a spring element in said annular recess for biasing said lip, in an embodiment said spring element comprises a circumferential coil spring clamped in said indentations.

In an embodiment, the sealing ring is made from PEEK or another polymer material having comparable properties at a cryogenic temperature. PEEK, or PolyEtherEtherKetone, retains flexible properties at low temperatures. In particular, it was found to retain its sealing properties at temperatures where for instance PTFE loses its required mechanical properties. Alternatives to PEEK are for instance polyimide (PI) and Polyamideimide (PAI). These thermoplastic materials also retain much of their properties at cryogenic temperatures. In an embodiment, the PEEK is unfilled or virgin PEEK. In an embodiment, the PI and PAI are also unfilled, virgin materials. Mixtures or combinations of these materials are also possible.

In an embodiment, the sealing ring comprises an annular recess opposite to said contacting surface and opening in a direction substantially opposite to said contacting surface. The annular recess provides a circumferential sealing lip opposite to the contacting surface. When positioned, said lip houses in an annular groove in the housing. Thus, the lip provides an integrated cup spring or Belleville spring washer. In order to function at cryogenic temperatures and maintain its sealing properties at low as well as high pressure, and also for said valve to require a manageable torque to be operated at these various conditions, the properties and details of the sealing rings are important. The above-mentioned materials, or materials which have similar properties, are preferred in sealing rings used as such. In fact, when the spring member or spring element is installed it is possible to use other materials which are commenly used in cryogenic application, for instance commenly used polymer materials. These polymers, often thermoplastic material used in sealing rings in cryogenic applications. It is, for instance, possible to use suitable polymer material like PTFE (polytetrafluorideethylene), PCTFE (polychlorotrifluorideethylene), PA (polyamide, nylon), combinations thereof, and compounds using these polymers. As stated above, in these cases the additional spring element is applied in the annular recess of the sealing ring. It is also possible to use the additional spring element in the sealing rings for PEEK and the like materials to even further improve the properties of the sealing ring.

In an embodiment, the at least one ball of said valves is a three-way ball valve in fluid connection between two of said ball valves configured as 2-way ball valves.

The invention further relates to a ball valve operative in a cryogenic temperature range, comprising a ball having a channel comprising at least one bend and outlet ends of said fluid channel of said ball not in line, said ball valve comprising a sealing ring comprising an annular, circumferential groove in a contacting surface where said sealing rings sealingly engage said ball. In the cryogenic temperature ranges, layers of ice easily form and get between the ball and its sealing ring, thus resulting in leakage. The groove seems to scrape the ice from the ball surface and retains ice and moisture in the groove.

The invention further pertains to a kit-of-parts for providing a ball valve described above, said kit-of-parts comprising at least one ball, at least two sealing rings, and a set of modular housing parts comprising a first modular housing part, and at least two second modular housing parts, said first modular housing part comprises at least one fluid passage sized for holding said ball and has two opposite coupling ends, and said second modular housing parts each comprising a fluid passage, an annular recess for holding one sealing ring, and a coupling end for coupling to one coupling end of said first modular housing part such that in a coupled position said sealing rings sealingly hold said ball in the fluid passage of said first modular housing part. In particular in cryogenic applications it was difficult to develop a properly sealing valve which allows a flexible design of fluid systems.

The invention further pertains to a sealing ring for a ball valve wherein said sealing ring is substantially made from a thermoplastic material having a Young's modulus between 2500 and 10000 MPa at room temperature and an elongation at break of at least 2% at a temperature below 80K. Thus, it was found suitable for use at cryogenic temperatures.

In an embodiment said thermoplastic material is PEEK.

In an embodiment of the sealing ring, it further comprises an annular, circumferential groove in a contacting surface where said sealing ring in use sealingly engages a ball of a ball valve.

In an embodiment of the sealing ring it has a contacting surface and further comprises an annular recess in said sealing ring opposite to said contacting surface for providing a spring lip for in use in a ball valve biasing said sealing ring against a ball.

The invention further pertains to an apparatus comprising one or more of the characterising features described in the description and/or shown in the attached drawings. The invention further pertains to a method comprising one or more of the characterising features described in the description and/or shown in the attached drawings.

The various aspects discussed in this patent can be combined in order to provide additional advantages. Furthermore, some of the features can form the basis for one or more divisional applications

### DESCRIPTION OF THE DRAWINGS

The invention will further be elucidated, referring to an embodiment of a ball valve assembly and multiple embodiments of a sealing ring for use in such a ball valve, showing in:

FIG. 1 a longitudinal cross-section of a ball valve assembly comprising three ball valves;

FIG. 2 a side view of the ball valve assembly of FIG. 1;

FIG. 3 a perspective view of a sealing ring;

FIG. 4 a cross-section of the sealing ring of FIG. 3 in radial direction, according to a first embodiment;

FIG. 5 a cross-section of the sealing ring of FIG. 3 in radial direction, according to a second embodiment;

FIG. 6 shows a top view of a cross-section of an embodiment of a ball valve in a three-way configuration, with the ball installed, and

FIG. 7 a detail of the ring of FIG. 5 mounted in an annular recess in the housing of FIG. 6.

### DETAILED DESCRIPTION OF EMBODIMENTS

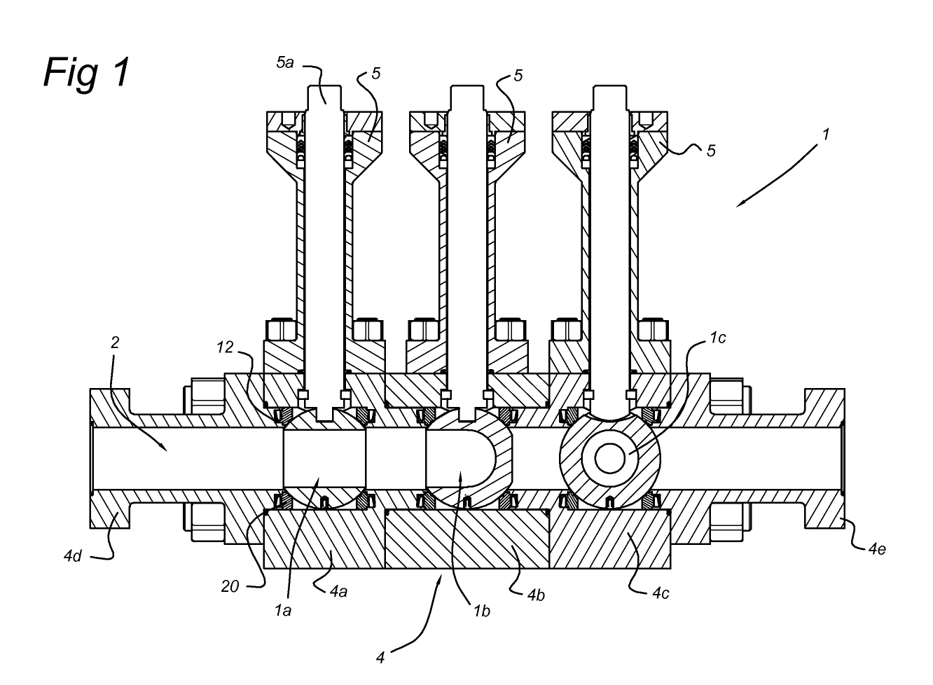

In FIG. 1, an embodiment of a assembly of ball valves 1 according to the invention is shown in longitudinal cross-section. Said assembly comprises three ball valves with three balls resp. 1a, 1b, 1c. The assembly of ball valves 1 comprises a central longitudinal valve body 4, which in this embodiment in essence has a cylindrical shape. The valve body 4 has a central fluid passageway 2 running through it in lengthwise direction. This longitudinal valve body 4 is divided in multiple sections, or modular housing parts, 4a-4e. If such a housing part 4a, 4b, 4c is provided with a ball 1a, 1b, 1c and sealing rings 20, for keeping a ball afloat, it constitutes a ball valve. The longitudinal valve body 4 is also provided with identical modular housing parts 4d and 4e forming end sections 4d, 4e. The modular housing parts 4a-4c, along with end sections 4d, 4e allow ball valves to be coupled in a desired assembly. In fact, the central modular housing part forms a first modular housing part and when provided with second modular housing parts like modular housing parts 4d and 4e it forms a single ball valve, in this embodiment the central ball valve provides a three way ball valve with one passageway invisible out of the paper or into the paper.

The balls 1a, 1b, 1c can be provided in 2-way or 3-way configurations, or basically, in any multi-way configuration, as long as physical constraints are satisfied. Each ball valve is connected to a transversal side body 5, which is shown on top of each respective housing parts of FIG. 1, and which runs in vertical direction. Each transversal ball valve body 5 has a canal running through it in a transversal direction with respect to the central fluid passageway 2. In this canal a stem 5a is placed to be rotatable around its longitudinal axis and which connects to a ball. It is provided for rotating its ball in its desired position. It is known that by providing a stem 5a attached to one part of the ball for rotating it, the ball can be rotated, as the stem can be rotated around its longitudinal axis. Furthermore, transversal fluid passageways 3 are connected to the central fluid passageways 2. These transversal fluid passageways 3 are not shown in the figure. In this embodiment the transversal fluid passageways 3 are placed with their lengthwise axis at an angle perpendicular to both the central passageway 2, and the transversal valve bodies 5, i.e. parallel to the viewing direction. However, in principle other placement angles can also be used.

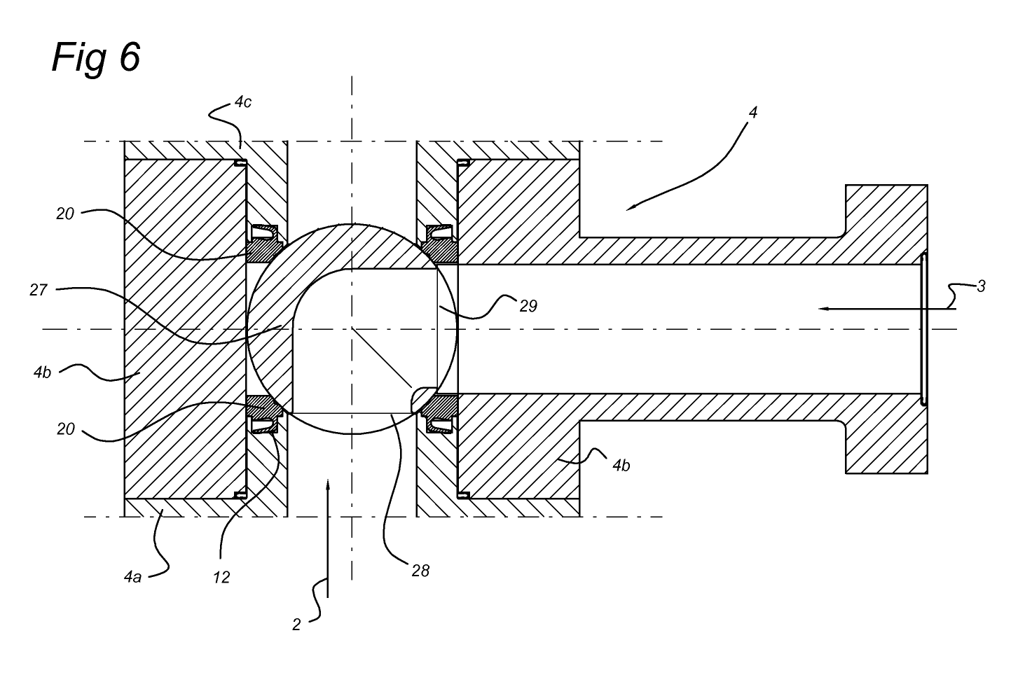

The junctions of the central passageways 2 and the transversal passageways 3 are provided with the balls 1a, 1b and 1c. Each ball 1a, 1b, 1c is comprised by a housing and two sealing rings 20. The balls 1a, 1b, 1c, the housing assembly 4a-4e, and sealing rings 20 constitute an assembly of ball valves. The sealing rings 20 are fitted on seat flanges 12, also referred to as annular recesses 12. The balls 1a, 1b, 1c float between the sealing rings 20. This will be elucidated in the description of FIG. 6. The balls 1a, 1b and 1c can be of any desired type in terms of fluid directing capabilities. E.g. in FIG. 1 ball 1a constitutes a conventional ball, which can be rotated in an open—i.e. letting fluid pass unimpeded—and a closed position, wherein the flow of fluid is inhibited. Balls 1b and 1c in this embodiment are of the asymmetrical type, which means fluid from the transversal fluid passageways 3 is guided by the balls 1b, 1c into the central passageway 2, and vice versa.

Also note that the assembly of ball valves 1 can indeed advantageously consist of multiple, inter-connectable ball valves. Each ball valve consists of a housing with modular housing parts 4a-4e, a ball 1a, 1b, 1c, and two sealing rings 20. The user can assemble any fluid control system he or she likes; a assembly of valves 1 in general comprises a housing part 4b with two end sections 4d, 4e, and of course a ball and two sealing rings. Subsequent housing parts 4a, 4c—with ball and sealing rings—can be added, as shown in the embodiment of FIG. 1, allowing ball valves to be coupled in any desired assembly. Additionally, even more sections can be added to the assembly in order to obtain the fluid control system the user would like to have.

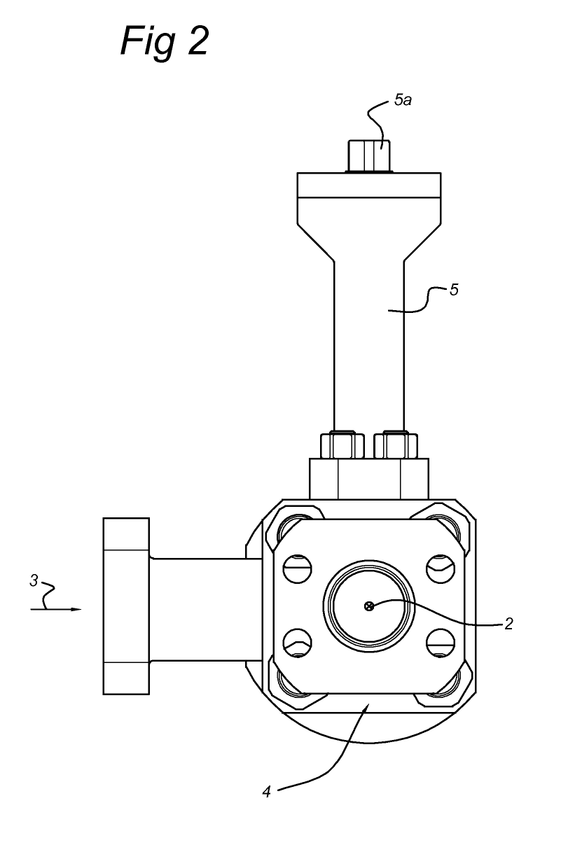

FIG. 2 shows a side view of the ball valve assembly 1 of FIG. 1. It shows the central passageway 2, parallel to the viewing direction, a transversal valve body 5, and a small part of the stem 5a. In this embodiment the transversal fluid passageway 3 is to be fluidly connected to the left part of the valve body 4.

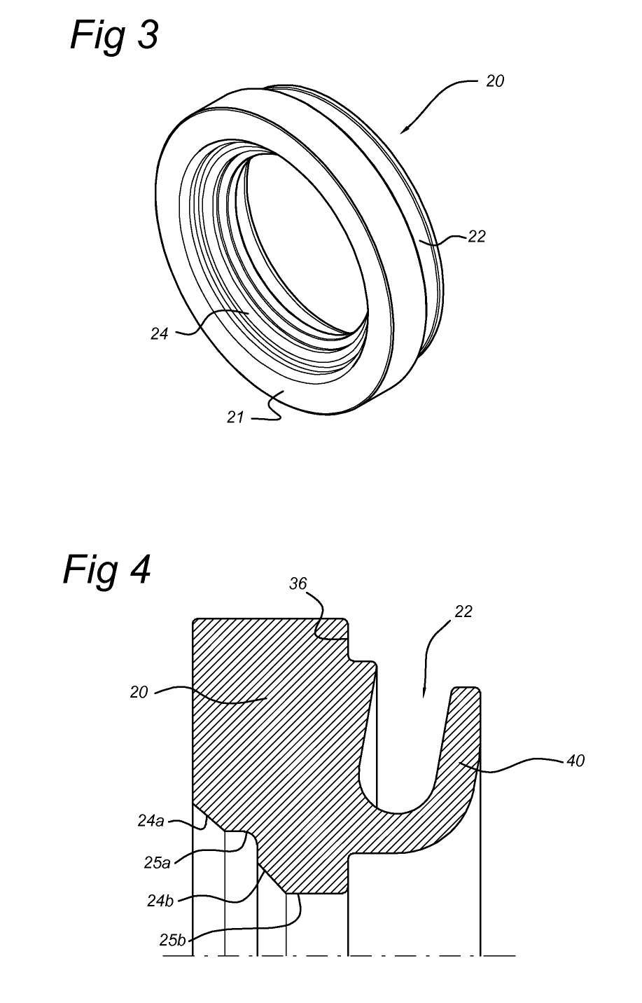

FIG. 3 shows a perspective view of an embodiment of sealing ring 20 according to the invention. The sealing ring 20 comprises an annular recess 22, as shown in the part of the sealing ring 20 to be fitted on the seat flange 12 or annular recess 12 of the housing. The recess can embedded accommodating a spring element, for instance a spring coil (not shown). The spring coil runs along the full circumference in the annular recess 22. The spring coil provides a tensile force to the circumference of that part of the sealing ring 20 connecting to the seat flange 12, thereby providing further fluid-sealed fit between a sealing ring 20 and a seat flange 12, especially at very low temperatures, such as cryogenic temperatures, and low pressure. Furthermore the inner diameter of the sealing ring 20 decreases from the ball side of the sealing ring 20 towards its interior in a step-like manner. This is for providing the scraping off contaminants like ice particles or other debris from the ball, which may be present on the ball or collect on the ball at very low temperatures. Furthermore, at higher temperatures moisture can be scraped off in a similar fashion. The contamination like ice or moisture is then contained within the recesses of the circumferential groove 25 of terraced area of the sealing ring 20. The sealing ring is preferably made out of PEEK, or a similar material with corresponding material properties, for instance polyimide (PI) or polyamidimide (PAI). For use at cryogenic temperatures, the virgin, unfilled material of these materials was found best suited.

FIG. 4 shows a cross-section of an embodiment of the sealing ring 20 of FIG. 3 in radial direction, according to a first embodiment. It shows the contacting surface 24, divided in two sections 24a and 24b, by a circumferential groove or recess 25a. Another circumferential recess 25b is here positioned near contacting surface 24b. The sections 24a and 24b of the contacting surface 24 have a radius of curvature corresponding to the radius of curvature of the ball. The sealing ring 20 thus has two sealing surfaces. Matching the curvature of the ball and the contacting surface 24 is thus less critical.

The annular recess 22 is in FIG. 4 provided with an inclination towards the centre of the sealing ring 20. Thus, the thickness of the lip is kept almost constant. FIG. 4 more clearly shows the previously mentioned step-like formation of the recesses 25a and 25b and contacting surfaces 24a and 24b, where the contacting surfaces 24a, 24b are designed in such a way as to scrape off contaminations, like ice particles, debris or moisture from the ball, and the recesses 25a, 25b are designed in such a way as to store the scraped-off contamination. Also the sealing ring 20 is designed in such a way that gas leaking out of the passageways, applies pressure in the annular recess and thus forces the lip against the wall of the housing. This decreases the possibility of gas leaking past the sealing ring 20. Also, the shape of the sealing ring 20 is such, that gas leaking past the ring actually improves the seal, by pressing it harder against the ball 27 and ball valve housing. This effect is particularly present at the location of the sealing ring's 20 annular recess 22.

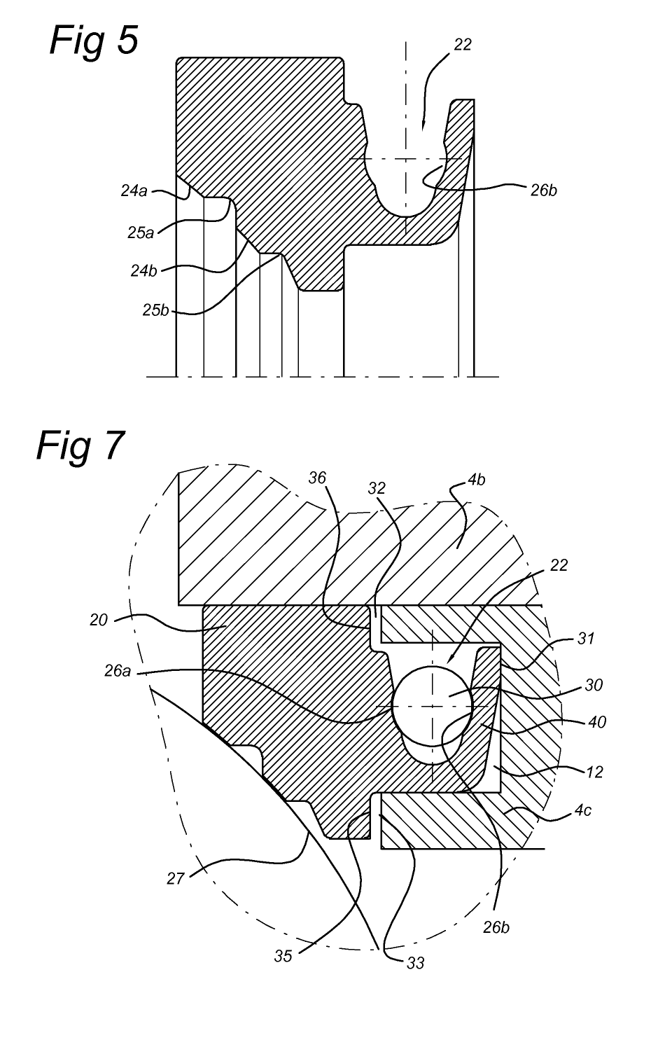

FIG. 5 shows a cross-section of sealing ring 20 of FIG. 3 in radial direction, according to a second embodiment. Again it shows the contacting surface 24, divided in two sections 24a and 24b by a recess 25a. Another recess 25b is positioned near contacting surface 24b. The sections 24a and 24b of the contacting surface 24 have a radius of curvature corresponding with the radius of curvature of the ball. The annular recess 22 is provided with a decrease in width towards the seat flange it is to be fitted on. Also, the annular recess 22 has a local increase in recess width. The total width increase at the location of local recesses 26a and 26b is derived from the cross-sectional diameter of a spring coil, as mentioned in the description of FIG. 3, which is to be placed therein in use. At lower pressures, the spring coil will force the lip outward, pressing the ring against the ball and thereby providing a better seal against leakage.

FIG. 6 shows a top view of a cross-section of an embodiment of a ball valve in a three-way configuration, with the ball installed. First note that the stem is not shown in the figure, but runs parallel to the viewing direction of the figure into the paper. The ball valve comprises a central passageway 2 fluidly connecting to an open outlet channel 28 of the ball 27. The ball 27 is also provided with an inlet channel 29 fluidly connecting to a transversal passageway 3. The inlet channel 29 and the outlet channel 28 are positioned at an angle of approximately 90° with respect to each other. This is for providing the possibility of fluidly connecting the two perpendicular passageways. By means of the stem (not shown) the ball 27 is rotatable around the axis perpendicular to both the transversal passageway 3 and the central passageway 2.

FIG. 6 furthermore shows the ball valve comprising two sealing rings 20, as pictured in e.g. FIG. 4 or FIG. 5, for keeping the ball 27 in place. The ball 27 floats between the sealing rings 20, which are shown in cross-section. The ball has an asymmetrical shape. The asymmetrical shape causes the ball 27 in case of temperature differences to expand and contract in an asymmetrical manner. The sealing rings 20 have been shaped in such a way that they can cope with this behaviour. By making the sealing ring 20 out of PEEK, or a similar material with corresponding material properties, the sealing ring 20's ability to deal with the asymmetrical expansion and contraction of the ball 27 is improved.

FIG. 6 also indicates lip pressing against the wall of annular recess 12 of the housing, pressing the sealing ring 20 against the ball 27. Also, gas leakage is further prevented by the shape of the sealing ring 20. As mentioned before, the shape of the sealing ring 20 is such, that gas leaking past part of the sealing ring 20 will actually improve the seal, by pressing it harder against the ball 27 and ball housing, which effect is particularly present at the location of the sealing ring 20's annular recess 22.

Furthermore, the sealing ring 20 in this embodiment is—as mentioned before—preferably made of PEEK, or another material having good low temperature properties, especially in the cryogenic temperature range. This material can for example comprise a similar plastic with corresponding properties.

FIG. 7 shows in detail the sealing ring of FIG. 5 in a detail of FIG. 6, positioned in annular recess 12 of the housing part 4c. On the opposite side of ring 20, part of a ball 27 resting against contact surface 24 is shown. Furthermore, part of housing part 4b is indicated. Annular recess 22 of the ring 20 defines lip 40 of the sealing ring 20. The sealing ring 20 further has circular abutment planes 35 and 36. In this embodiment, these abutment planes 35 and 36 are substantially in one plane. The distance between that plane and abutment surface 31 of lip 40 is in the drawing indicated with D. In this embodiment, the side walls of the annular recess 22 of sealing ring 20 has opposite indentations 26b and 26a. In the annular recess, a spring element 30 is provided. This spring element 30 is to bias lip 40 in the outward direction. In this embodiment, spring element 30 is an endless coil spring in annular recess 22. It is kept in place through circular indentations 26a and 26b.

The sealing ring 20 is positioned in the modular housing parts 4b, 4c with its lip 40 and annular recess 22 in annular recess 12 of modular housing part 4c (a second modular housing part). The depth of the recess 12, in fact a rectangular groove in this embodiment, is less than distance D. Thus, spaces 33 and 32 remain when sealing ring 20 is positioned in recess 12 with abutment surface 31 of lip 40 resting against bottom 34 of recess 12. After the ball is mounted into the housing, it presses against contacting surface 24 of sealing ring 20. Thus, the width of spaces 32 and 33 is a little reduced. The abutment surface 31 now presses firmly against the bottom 34 of recess 12. In this way, the position of the ball can shift a little, keeping the ball 27 afloat, but keeps sealing rings 20 pressed against ball 27.

It will also be clear that the above description and drawings are included to illustrate some embodiments of the invention, and not to limit the scope of protection. Starting from this disclosure, many more embodiments will be evident to a skilled person which are within the scope of protection and the essence of this invention and which are obvious combinations of prior art techniques and the disclosure of this patent.

1-20. (canceled)

21. A ball valve operative in a cryogenic temperature range, said ball valve comprising a housing comprising a fluid passage therethrough, a ball rotatably positioned in said housing in said fluid passage and comprising a fluid passage therethough, said fluid passage of said housing and said fluid passage of said ball provided to allow fluid through said ball valve when said ball is in an open position and to block said fluid when said ball is rotated from said open position into a closed position, wherein said housing comprising at least two sealing rings disposed in said housing, and sealingly contacting said ball and positioned for rotatably holding said ball between said at least two sealing rings, said sealing rings comprising at least a surface layer of thermoplastic material contacting said ball surface comprises an annular, circumferential groove in a contacting surface where said sealing rings sealingly engage said ball and an annular recess in said sealing ring opposite to said circumferential groove for providing a spring lip for biasing said sealing ring against said ball.

22. The ball valve of claim 21, wherein said housing comprises at least two annular recesses adjacent to said ball and each holding a sealing ring disposed with its sealing lip in said annular recess to sealingly press said contacting surface against said ball.

23. The ball valve of claim 21, wherein said thermoplastic material contacting said ball surface has a young modulus between 2500 and 10000 MPa at room temperature and an elongation of at least 2% at a temperature below 80K.

24. The ball valve of claim 21, wherein said ball valve has an asymmetric mass distribution due to its fluid passage.

25. The ball valve of claim 21, wherein said passage through said ball is not a straight channel through said ball.

26. The ball valve of claim 21, wherein said passage through said ball comprises at least one bend.

27. The ball valve of claim 21, wherein said housing comprises at least two modular housing parts.

28. The ball valve of claim 27, wherein a first modular housing part comprises
at least one fluid passage end dimensioned for housing the ball and having two opposite coupling ends, and a second modular housing part comprising a fluid passage, an annular recess for holding one sealing ring at one end of the fluid passage, and a coupling end for coupling to one coupling end of said first modular housing part such that in a coupled position said sealing ring presses its contacting surface against the ball.

29. The ball valve of claim 21, wherein said fluid passage of said ball comprises a bend and said housing comprises at least three fluid passage ends connecting to said ball and wherein said fluid passage of said ball and said fluid passage ends of said housing arranged with respect to said ball and said fluid passage of said ball to allow interconnection of sets of two fluid passage ends.

30. The ball valve of claim 21, wherein said sealing ring is substantially made from said polymer material.

31. The ball valve of claim 21, wherein said sealing ring comprises at least a core of said polymer material.

32. The ball valve of claim 21, wherein said sealing ring is substantially from said polymer material and comprising spring element in said annular recess for biasing said lip in outward direction.

33. The ball valve of claim 21, wherein said sealing ring is made from PEEK or another polymer material having comparable properties at a cryogenic temperature.

34. A valve assembly comprising at least three valves according to claim 21, wherein at least one ball of said valves is a three-way ball valve in fluid connection between two of said ball valves configured as 2-way ball valves.

35. A ball valve operative in a cryogenic temperature range, comprising a ball having a channel comprising at least one bend and outlet ends of said fluid channel of said ball not in line, said ball valve comprising a sealing ring comprising an annular, circumferential groove in a contacting surface where said sealing rings sealingly engage said ball.

36. Kit-of-parts for providing a ball valve according to claim 21, said kit-of-parts comprising at least one ball, at least two sealing rings, and a set of modular housing parts comprising a first modular housing part, and at least two second modular housing parts, said first modular housing part comprises at least one fluid passage sized for holding said ball and has two opposite coupling ends, and said second modular housing parts each comprising a fluid passage, an annular recess for holding one sealing ring, and a coupling end for coupling to one coupling end of said first modular housing part such that in a coupled position said sealing rings sealingly hold said ball in the fluid passage of said first modular housing part.

37. A sealing ring for a ball valve, in an embodiment according to claim 21, wherein said sealing ring is substantially made from a thermoplastic material having a young modulus between 2500 and 10000 MPa at room temperature and an elongation of at least 2% at a temperature below 80K.

38. The sealing ring of claim 37 wherein said thermoplastic material is PEEK

39. The sealing ring of claim 37, further comprises an annular, circumferential groove in a contacting surface where said sealing ring in use sealingly engages a ball of a ball valve.

40. The sealing ring of claim 37, having a contacting surface and further comprising an annular recess in said sealing ring opposite to said contacting surface for providing a spring lip for in use in a ball valve biasing said sealing ring against a ball.
